(19) United States
(12) Patent Application Publication
(10) Pub. No.: US 2011/0143952 A1
(43) Pub. Date: Jun. 16, 2011

(54) CHROMATOGRAPHIC DEVICE AND METHOD OF FABRICATION AND CHROMATOGRAPHIC METHODS

(76) Inventors: Alastair Charles Lewis, York (GB); Jacqueline Fiona Hamilton, York (GB); Christopher Neil Rhodes, York (GB)

(21) Appl. No.: 13/000,749

(22) PCT Filed: Jul. 3, 2009
(86) PCT No.: PCT/GB09/50783

§ 371 Date: Mar. 3, 2011

(30) Foreign Application Priority Data
Jul. 3, 2008 (GB) 0812190.7

(51) Int. Cl. C40B 30/02; B01D 53/02; C03C 15/00

(52) U.S. Cl. 506/8; 96/104; 216/83

(57) ABSTRACT

A chromatographic device for use in multi-dimensional GC is described having a gas flow channel means having an inlet and an outlet, and including a first length of tube defining a first stage and a second length of tube defining a second stage; wherein each of the first length of tube defining a first stage and second length of tube defining a second stage is microfabricated in the plane of a planar substrate layer such that each length of tube comprises a bore defining a closed curve in cross section. A GC assembly further comprising modulator, injector and detector and a method of fabrication of device and assembly are described. A method of analysing multi-dimensional GC data is described.

The invention relates to a chromatographic device for the performance of comprehensive multi-dimensional gas chromatography (GC), to a method of fabrication of such a device, to a method of performance of comprehensive multi-dimensional gas chromatography using such a device and to a method of processing multi-dimensional gas chromatography data, especially in the form of chromatograms.

Gas chromatography is a major analytical method and is used throughout environmental science to detect and identify chemicals in air, water and soils. The size and power consumption of current commercially available instruments is such that they are used almost exclusively in the laboratory and are not field portable.

Comprehensive multi-dimensional gas chromatography, or GC×GC, is a gas chromatographic technique in which at least some components of the sample are subject to a multiple stage separation, and for example at least a two stage separation, using multiple columns mounted in series and set up in a manner which substantially preserves separation from the first stage through the second (or further) stages. The technique was described in U.S. Pat. No. 5,196,039 to Philips and Liu.

In accordance with this technique, the sample is first separated on a first stage capillary GC column, which typically operates at lower separation rates. The effluent of this first column is focused into a number of narrow adjacent resolved bands by a suitable interface, often termed a modulator, and these are successively injected onto a second stage capillary GC column which is typically structured to operate at much more rapid separation rates. Thus, the retention time in the second stage can be configured to be less than the band resolution time of the first stage preserving the first stage separation through the second stage.

In a true multi-dimensional separation, the separation methods must operate independently, or be “orthogonal”. In the case of GC×GC, provided that the sample exiting the first stage is sampled frequently enough, the separation of the first dimension is substantially preserved as it is injected into the second stage, and the sample is thus subjected to both separate dimensions. In effect, the method is a two-dimensional separation method in which very many sequential heart cuts are taken at an interval which is short enough to give effective orthogonality.

Thus, a basic requirement can be defined that there must be at least two orthogonal GC columns coupled by a functional interface or modulator that is capable of collecting material from the first column and periodically injecting it into the second stage at a rate that substantially preserves the first separation dimension. A variety of modulators, either valve-based or based on thermal systems, have been developed to ensure this transfer between the two GC columns.

Properly constructed, a comprehensive two-dimensional gas chromatography apparatus can confer a number of advantages. However, the apparatus is a potentially complex construction. The two columns, operating at different separation speeds, are necessarily differently configured. The first column is typically of conventional capillary design. The second column is a fast GC which is usually a shorter and narrower bore column. There is a need for a modulator at the interface. Careful and accurate connection of the components is required in order to obtain effective results. This criticality of connection also makes reproducibility of results between systems difficult.

The separation data that results has at least two dimensions. It can conveniently be presented in a chromatogram in those two dimensions, with a retention time in a first stage along one axis of the chromatogram and a retention time in a second stage along another axis. Intensity or quantity data may be represented also in the chromatogram, for example by colour, brightness or hue or by the use of a third dimension.

GC×GC offers potential for the analysis of sample types that cannot be analysed by one dimensional GC, and offers the potential for results which can be presented in striking manner in visual appearance. However, typical apparatus is not always easily useable, requiring careful construction that may involve both intricate hardware and software solutions, that is difficult to build in the field, and that is difficult to assemble in a manner to allow reproducible results susceptible of cross comparison.

U.S. Pat. No. 7,273,517 describes a non-planar microfabricated gas chromatography column fabricated by providing a planar substrate with a plurality of through holes in a direction perpendicular to the plane of the substrate. A top lid and a bottom lid are bonded to opposite surfaces of the planar substrate to link the through holes in such manner that they form a fluidly continuous channel suitable for lining with an appropriate stationary phase to serve as a GC column. A planar heating or cooling element may be disposed on at least one of the lids.

The column is non-planar and the bulk of the flow length in the column is constituted by the through holes and so lies in a direction perpendicular to the plane of the substrate. This produces a tortuosity of flow that is greater than in a planar device, with reductions in the efficiency of the separation. Moreover, the use of the planar heating or cooling element on a non-planar separation device results in a longitudinal temperature gradient along sections of the column. Large thermal gradients along the length of any column are generally undesirable for GC.

The present invention seeks to overcome or at least mitigate some of the above discussed drawbacks of current multi-dimensional GC instruments.

In accordance with the invention in a first aspect there is provided a chromatographic device for use in multi-dimensional GC comprising:

a gas flow channel means having an inlet and an outlet, and including a first length of tube defining a first GC stage and a second length of tube defining a second GC stage;

wherein each of the first length of tube defining a first stage and second length of tube defining a second stage is microfabricated in a planar substrate layer such that each length of tube extends in the plane of the substrate layer and comprises a bore defining in cross section a closed curve, and in particular being substantially circular in cross section.

This device is suitable for use in an assembly for multi-dimensional GC which when so assembled will further comprise:

injector means to introduce a sample entrained in carrier gas through the inlet and into the first stage, for example including a thermal desorption module;

a modulator at the end of the first stage to accumulate successively over successive time periods concentration fractions of sample received at the end of the first stage and to release each accumulated fraction as a concentration pulse into the second stage;

a detector to receive separated sample from the outlet of the second stage.

The inlet and outlet of the chromatographic device of the first aspect of the invention may be adapted to facilitate connection of such additional components for example by provision of appropriate standard connectors. Alternatively some or all of such additional components may be integrally formed with the device.

The essence of the invention is that the first length of tube defining a first stage and second length of tube defining a second stage are each microfabricated to an appropriate geometry in a planar substrate layer. In the context of this application, this means that each of the first length of tube defining a first stage and second length of tube defining a second stage is fabricated on a sub-millimeter scale, for example to a bore diameter of below 0.5 mm, being created therein via a suitable microfabrication technique.

The tubes are for example etched. The tubes may be etched via a lithographic technique. Conveniently the tubes are fabricated via a chemical etch process and in particular are created by wet chemical etching. The tubes are preferably isotropically etched (that is, etched via a process that removes glass substrate sideways and downwards at approximately the same rate). This forms the curved structures of the invention in an effective manner and discussion by way of example below makes use of this process. However the structure is not limited by fabrication process. Alternatively the tubes may be microfabricated via a physical material removal technique, such as laser etching or engraving, micromachining or similar. Alternatively the tubes may be microfabricated into the substrate via a micromoulding or micropressing technique.

Combinations of techniques may be used, for example for different structures.

Etched silicon structures have found some recent application in microfludic work with liquids, especially bioliquids, for example in the form of so-called lab on chip technology. Such structures are often formed as channels or trenches with normal or near-normal side walls. This does not necessarily pose undue difficulties for liquids work, but such side wall structures do not parallel effectively the curved-walled and especially circular- or near-circular-walled capillary structures conventionally presented by drawn tube columns used for gas chromatography.

In particular, it is generally a requirement of gas chromatography that a stationary phase is laid down on a tube bore in a consistent and predictable manner so that separation effects are consistent and reproducible. In structures having substantially circular bores a stationary phase can be coated onto the bore in liquid form in a manner where the surface tension of the liquid will ensure a reasonably consistent distribution, as will be familiar. This technique cannot be applied to straight sided structures, where the stationary phase would tend to collect in the corners.

In accordance with the invention, curved-walled, and especially circular- or near-circular-walled tubular structures are microfabricated within a planar substrate to define closed curves, especially in that they do not have straight vertical sides, and preferably in that they are continuously curved and for example elliptical or generally circular, and can thus function as conventional GC structures, in particular as regards creation of a suitable stationary phase. It will be appreciated by the skilled person that the advantages of the invention do not require a strict circular geometry.

Closed continuous curve tube bores of any geometry offer advantages over those with planar sides although generally circular bores even if they deviate from strict geometrical circularity, for example in that a major and a minor diameter differ by no more than 10%, will be preferred.

Conveniently, the planar substrate layer comprises a sandwich structure in which complementarily microfabricated curved and for example substantially semicircular grooves are formed on facing surfaces of a pair of opposing sandwich layers, and the layers are brought together to form a planar substrate layer and complete the said first and second lengths of tube.

In a particularly preferred embodiment, the planar substrate layer is a planar glass substrate layer. Preferably, the said first and second lengths of tube are acid etched structures. Preferably the planar glass substrate layer comprises a sandwich structure as above, for example in that an opposing surface of each layer is provided with an acid etched substantially semicircular groove.

Chemically etched structures in glass sandwich structures so formed have been found to exhibit the particular advantage of potentially mimicking much more closely the cross-sectional profile of capillary structures in drawn tube columns. Tubular structures can be etched within the glass substrate that present a cross-sectional profile to the carrier gas and entrained sample that is essentially functionally equivalent to that in a drawn tube. Essentially conventional and well understood principles of GC×GC fluid mechanics can thus be applied to devices incorporating such structures. In particular, conventional stationary phases can be used which are formed in tube bores via conventional methodologies.

However, the invention is not limited to glass substrate layers but encompasses any microfabricated structures in any suitable compact planar substrates which have the necessary curved-walled, and especially circular-walled, bore structures described above.

In accordance with the invention, both dimension stages of an effective GC×GC device can be fabricated integrally on a single planar substrate in a compact manner. A suitable substrate might be a square or rectangular substrate with a side dimension of 150 mm or less but still accommodate first and second stage column lengths, as microfabricated structures within the substrate layer, which are sufficient to provide the two orthogonal columns of an effective GC×GC instrument.

The chromatographic device of the first aspect of the invention is thus compact and portable. Many of the connection problems associated with conventional assembled column devices for GC×GC are reduced or eliminated, since many of the connections are inherent in or fabricated into the microfabricated structure. Reproducibility of results, both for a single device, and between devices of a common design, is offered.

A further advantage can be identified in relation to heating and cooling of each column stage. In conventional GC×GC assemblies, the columns are typically heated/cooled by being retained in an oven volume and air heated/cooled. Where it is desirable, a second column can be contained within a second oven imposing a different temperature regime from the first, but this imposes even greater complexity on the assembly. The ability to vary temperature, and in particular to cool below ambient, is constrained by the limitations imposed by air cooling, and the operating temperature range of conventional assembled column instruments is consequently limited.

By contrast, the simple planar device of the present invention lends itself to much more flexibility as regards heating and, and in particular, cooling. Because each of the tubes making up the first and second stages extends in the plane of the substrate (that is, has an elongate direction parallel to the plane of the substrate), this minimizes any thermal gradient in the longitudinal direction of the separation if heating or cooling is applied via a means acting at a surface or surfaces of the substrate. At most, any thermal gradient is generated only across a tube width. This can be contrasted with the situation when a device such as illustrated in U.S. Pat. No. 7,273,517 is heated by a planar heater. A substantial tube length is disposed perpendicular to the plane of the substrate and a resultant thermal gradient in a longitudinal direction of much more than a single tube width will be experienced by a fluid sample in use.

In a preferred embodiment, the device further comprises heating and/or cooling means disposed to heat and/or cool, independently or together, some or all of: the first length of tube defining a first stage, the second length of tube defining a second stage, a modulator, or any other functional component of a more comprehensive system in relation to which it might be desirable to control temperature.

A suitable heating and/or cooling means to maintain a desired temperature for some or all of: the first length of tube defining a first stage, the second length of tube defining a second stage, a modulator, especially where these are integrally formed in a single planar substrate, is preferably a planar structure, and is for example disposed in an assembled device structure adjacent or in sufficiently close proximity to the glass substrate layer containing the tubes making up each GC stage. The planar heater may act to heat the substrate, for example via conduction, to maintain the desired temperature of the first stage and/or second stage and/or modulator. The first length of tube defining a first stage, the second length of tube defining a second stage, and the modulator may be provided with separately controlled heaters or a heater with separately controlled heating zones.

Control of the heating and cooling of each stage is enabled. In particular, an operating range extending substantially below ambient is made much more practical. Separate heating of the first and second stages is made easier.

Whereas a planar heater disposed to heat a substrate via conduction might be suitable for maintenance of appropriate temperatures in the columns and modulator, a more rapid heating cycle may be required for a concentration structure, for example incorporating a concentration medium, such as carbon black, and operating on thermal desorption principles. It might be undesirable to subject the substrate to such more rapid thermal cycling due to induction of mechanical stresses associated with inhomogeneous material expansion. Heating of the concentration structure via conduction of heat through the substrate may be induced for example through resistive heating of materials directly in contact with the substrate. Such a means of heating results in a high temperature contact point between substrate and heating element where stress may be induced. Alternatively a suitable heating means for a concentration structure is conveniently a placed heater spaced from and configured to act directly upon the concentration structure through infrared radiation rather than indirectly via conduction of heat from the substrate, for example in that it acts to heat a concentration medium. For example the means comprises a radiant heater or an inductive heater such as a halogen lamp.

A radiant heater present a particularly effective heating means where a concentration medium is contained within a volume in a transparent substrate, such as in the preferred embodiment of the present invention a glass substrate. There is a particularly effective synergy between a radiant heater and a concentration structure such as strongly infrared absorbing carbonaneous materials in a substrate such as a glass substrate which itself is largely transparent to radiant heat which is passed in the infrared. The concentration medium may be heated directly without any significant heating of the substrate. This may be a contrasted with the case with substrates such as silicon substrates that are relatively less transparent for infrared radiation, or metallic substrates which have no transparency.

In accordance with the invention, at least each of the lengths of tube making up the first and second stages is fabricated into a planar substrate layer such as a planar glass substrate layer. The device functions otherwise as a conventional GC×GC structure, the microfabricated lengths of tube in the invention functioning in like manner to the drawn capillary tubes of conventional two-dimensional GC apparatus. It is an advantage of the present invention that a microfabricated GC column structure making up a stage within a planar glass substrate layer can be fabricated in a manner which more closely mirrors the internal geometry of conventional columns. In particular, the structures are not fabricated in the form of straight sided channels, but form a continuous closed curve, and most preferably have a generally circular cross section to correspond geometrically to the bore of a conventional tube. The general principles of GC×GC separation can be applied, and the skilled person will readily understand and apply those general design principles in developing a GC×GC device in accordance with the principles of the invention.

In particular, the first stage will typically be configured as a conventional, slower separation rate column and the second stage will typically be structured to operate at much more rapid separation rates, and for example be shorter and optionally further have a narrower bore. Such general design principles will be familiar. The microfabrication technique of the present invention will in principle allow a selection of first and second stage structures corresponding to a range of conventionally known designs.

Suitable first and second stage tubular formations will suggest themselves to the person skilled in the art by analogy with conventional assembled column structures. Dimensions will also be governed in a preferred case by the desire to maintain a relatively compact planar substrate structure. A suitable planar substrate structure might for example measure no more than 150 mm by 150 mm, and more preferably no more than 90 mm by 90 mm. Suitable column lengths in such structures might for example be 1 m to 30 m, and in particular 1 m to 10 m for a first stage, and 0.1 m to 2 m for a second stage, with a ratio of first to second stage column length of between 5 and 10 to 1 as will be familiar. Suitable bore diameters will be of the order of 0.05 mm to 0.50 mm. Preferably, the second stage will have a narrower bore than the first stage. For example, a suitable bore diameter for the second stage will be 0.1 mm to 0.3 mm and for the first stage 0.25 mm to 0.50 mm.

Each tube bore making up each stage is lined with a suitable stationary phase for retaining sample substances in conventional manner. Again, since it is a desirable feature of the invention that it corresponds most closely, as regards the conditions within the bore of each stage, to a conventionally drawn column, the selection of stationary phase may be entirely conventional.

As will be familiar, the first stage will typically comprise a generally non-polar stationary phase. The second stage needs to provide for a second dimension separation which must be relatively very fast, must be performed with a stationary phase that is different from that used in the first stage, and is usually performed by a stationary phase that offers more polar characteristics. Stationary phases are for example based on polysiloxanes and waxes.

The combined system will be operated in conventional manner so that the two stages are functionally orthogonal. This requires a modulator configured to sample material exiting the first stage frequently enough to substantially preserve the separation in the first dimension in familiar manner. The modulator will thus operate in accordance with well established principles for GC×GC systems by sampling and concentrating material from the first column and periodically introducing it to the second column at a rate that allows the first dimension separation to be substantially preserved.

Thus, in use, a sample is injected into the system for example entrained in carrier gas. The sample is concentrated as required for injection, for example by means of a thermal desorption trap. The injected sample is subject to a first dimension separation in the first stage. The resultant material from the first stage column passes to the modulator. The modulator collects a sample of or all of the material that enters it during a relatively short sampling bandwidth period, and injects the fraction so collected into the second stage as a short chromatographic pulse. The modulator collects a further fraction while the previous fraction is being separated in the second stage. The process repeats successively. In order to preserve the separation achieved in the first dimension, it is generally considered that each peak eluting from this dimension should be sampled at least three times across its width by the modulator. In practice many more separations might be desirable.

It is generally necessary that, for full orthogonal GC×GC operation, the retention time within the second section is less than the band resolution time of the first section. The second stage then performs a separation independently of the separation in the first stage, with the separation in the first stage also being substantially maintained. The material with this two-dimensional separation is passed to a detector and the results processed in the usual manner. The detailed dynamics of the process will be familiar to the person skilled in the art.

In accordance with a more complete embodiment of the invention a suitably configured modulator is provided between the first stage and the second stage. The precise design of modulator is not necessarily pertinent to the invention. However, in a preferred embodiment, the modulator is also at least in part microfabricated into a planar device structure, for example into a planar substrate layer containing a GC stage or stages or into a further layer fluidly connected thereto and forming therewith a planar substrate structure. For example, at least, the modulator is in part composed in a microfabricated modulator volume in fluid communication with and lying fluidly between the first and the second stages, and is for example etched and for example wet chemical etched integrally with the first and second stages. In the preferred case, all fluidic components of the modulator which form part of the sample flowpath are microfabricated within the planar substrate layer, but this preferred embodiment does not exclude the provision of other externally connected components such as mechanical flow control valves which control the fluidic enablement of the modulator and the like, electronic means etc.

In a convenient embodiment, the modulator is a valve-based modulator. In particular, the valve-based modulator is a differential-flow modulator that samples all of the primary column effluent.

Differential-flow modulation generates a succession of pulses by collecting effluent from the first column in a sample loop and then periodically using an auxiliary flow to flush the sample loop into a second column. If the auxiliary flow rate is substantially higher than the first column flow rate then the sample loop contents will be flushed in less time than is needed to fill the loop. In accordance with a preferred embodiment of the invention, the sample loop structure at least is microfabricated in the manner above described.

For example, in a particularly preferred embodiment, the modulator comprises, in fluid series between the first and the second stage, a first three-port junction at an outlet of the first stage, an intermediate length of tube, a second three-way junction fluidly connecting to the second stage, and a valve means connected in parallel to the intermediate tube so as to apply a periodic auxiliary flow to flush sample from the intermediate tube into the second stage as successive pulses. Conveniently, the junction structures and the intermediate tube are fabricated integrally with the first and second stage in a suitable planar substrate layer.

The principles of differential-flow modulators are known. The practical difficulties of constructing a differential-flow modulator in an assembled column, with the need to assemble micro-volume T-Junctions and short intermediate column lengths, have limited the practical use of such modulators. Fabrication of at least these parts of the structure into a common planar substrate layer, with only the valve means requiring external connection, makes such a modulator more practical.

The invention does not preclude the use of other modulators, whether fabricated as part of the planar device structure of the invention or otherwise fluidly connected therewith, for example including thermal modulators or other valve based modulators or combinations.

In accordance with a more complete embodiment of the invention a suitably configured sample concentration structure is provided upstream of the first stage. The sample concentration structure may comprise a thermal desorption module. The precise design of sample concentration structure is not necessarily pertinent to the invention. However, in a preferred embodiment, the concentration structure is also at least in part microfabricated into a planar device structure, for example into a planar substrate layer upstream of the first stage to act in use, for example with suitable thermal means, to concentrate a sample prior to injection into the first stage in familiar manner. Preferably, a concentration structure comprises a microfabricated volume incorporating a suitable concentration medium. For example, the concentration medium comprises a carbon bed. For example, at least, the sample concentration structure comprises a microfabricated thermal desorption trap comprising a suitable concentration medium disposed in a microfabricated volume in fluid communication with and lying fluidly upstream of the first stage, and for example etched and for example wet chemical etched integrally with the first and second stages. In the preferred case, all fluidic components of the thermal desorption module are microfabricated within the planar substrate layer, but this preferred embodiment does not exclude the provision of other externally connected non-fluidic components such as mechanical devices, electronic means etc.

Further functional structures may be provided in a planar substrate layer carrying one or more GC stages and/or modulator and/or injected sample concentrator structures or in another layer.

Preferably, a planar substrate layer is a glass layer, and more preferably an alkali metal oxide glass layer. Such substrates are readily acid etched to produce desired tubular structures more closely corresponding to those in conventional columns.

Preferably, the planar glass substrate layer is formed as a sandwich structure in which complementarily curved and for example semicircular grooves are acid-etched in each of a pair of layers which are then brought into intimate contact, and for example suitably bonded, to create each of the first length of tubing defining a first stage and a second length of tubing defining a second stage, and other microfabricated structures as applicable. In a convenient embodiment, a sandwich structure comprises a first relatively thinner layer and a second relatively thicker layer, so that the resultant tubes are close to one of the surfaces of the assembled sandwich. This enables the provision of heating and cooling means in close proximity to the tubes on that surface.

The planar glass substrate layer may be combined with other layers to form a planar substrate structure. Other layers making up such a planar substrate structure may be of other materials and/or may carry other active structures. A planar substrate structure may have more than one glass substrate layer carrying an active structure, for example a capillary column, a modulator, or another structure, the multiple layers each carrying at least one such active structure and being fluidly connected to make up a whole.

The foregoing describes an example of the invention in which a single first stage and a single second stage are provided. Multi-dimensional GC is known with multiple columns two or more of which are independently dimensioned. Similarly, the present invention is not limited to an embodiment comprising just two independently dimensioned columns. In accordance with a possible embodiment in the invention, third or subsequent stages can be provided in fluid series. For example these can be fabricated into a single planar substrate layer such as a single planar glass substrate layer or into plural fluidly connected substrate layers in the same manner as the first and second stages.

A device of the invention can be incorporated into a multi-dimensional GC measuring instrument of compact design that is particularly suited to non-lab use, especially in that power consumption is minimised. In a preferred embodiment, a multi-dimensional GC measuring instrument is provided to operate at power consumption below 100 W and/or is provided in combination with a non-mains power source and especially a power source providing for operation from solar/wind charging.

In accordance with the invention in a further aspect there is provided a method of fabrication of a chromatographic device for use in multi-dimensional GC comprising the steps of:

providing at least one planar substrate layer;

microfabricating within the planar substrate layer(s) a fluidly continuous gas flow channel means having an inlet and an outlet, and including a first length of tube defining a first stage and a second length of tube defining a second stage;

such that each length of tube extends in the plane of the substrate layer and comprises a bore defining in cross section a closed curve, and in particular being substantially circular in cross section.

In a convenient embodiment of the method the planar substrate layer comprises a sandwich structure in which a length of tube is fabricated by means of:

forming complementarily patterned curved and for example substantially semicircular grooves in opposing surfaces of each of a first and second layer of a sandwich structure;

bringing the first and second layers of the sandwich structure into contact and for example bonding to form a length of tube defining in cross section a closed curved and for example a substantially circular bore constituting each stage as hereinabove described.

In a convenient embodiment of the method the planar substrate layer is optionally combined with other layers to form a planar substrate structure. Additional layers may be provided with additional support and/or active device structures.

Preferably, the microfabrication method used to fabricate at least the first length of tube defining a first stage and the second length of tube defining the second stage comprises a lithographic technique, for example chemical etching and most preferably wet chemical etching. Preferably, an isotropic etching method is used. Additionally or alternatively the tubes may be microfabricated via a physical material removal technique, such as laser etching or engraving, micromachining or similar and/or the tubes may be microfabricated into the substrate via a micromoulding or micropressing technique. Combinations of techniques may be used, for example for different structures.

Preferably, the planar substrate layer comprises a planar glass substrate layer. Preferably, at least the first and second lengths of tube, and where applicable other structures microfabricated therein, are formed by wet chemical etching and in particular by acid etching. For example, an etch based on HF is used.

In a more complete embodiment, the method is a method of fabricating a chromatographic assembly for use in multi-dimensional GC comprising one or more of the further steps of:

providing in fluid communication between the first stage and the second stage a modulator adapted in use to accumulate successively over successive time periods concentration fractions of sample received at the end of the first stage and to release each accumulated fraction as a concentration pulse into the second stage;

providing fluidly upstream of the first stage injector means to introduce a sample entrained in carrier gas through the inlet and into the first stage; providing fluidly downstream of the second stage a detector to receive separated sample from the outlet of the second stage.

Further features of the fabrication method will be appreciated by analogy with the preferred features of the device described hereinabove.

In accordance with a further aspect of the invention a device in accordance with the first aspect of the invention can be used to generate two-dimensional GC×GC results when connected to a suitable detector. A method of performance of comprehensive multi-dimensional gas chromatography comprises using such a device to generate two-dimensional GC×GC results. As will be familiar, these two-dimensional results can provide the user with increased separation power, increased sensitivity, and in particular highly structured, ordered chromatograms that present the two dimensions of information in physical dimensions on the chromatogram. Such a chromatogram represents a first dimension of separation on a first axis and a second dimension of separation on a second axis. Brightness or hue may be used to represent intensity of signal/quantity of material separated. Alternatively, the third dimension may be used in this way. In a preferred embodiment of this aspect of the invention the method comprises generating two-dimensional chromatograms from two-dimensional GC×GC results.

In accordance with a further aspect of the invention, a method of processing separation data from a multi-dimensional GC apparatus to obtain information concerning a sample comprises the steps of:

providing a library of datasets of multi-dimensional chromatography data representing reference conditions for example comprising standard or default conditions or the absence or presence of particular target materials, comprising at least two-dimensional separation, from which pattern feature data for a two-dimensional chromatogram representing each dataset can be obtained;

injecting a sample under test into a multi-dimensional GC apparatus; operating the apparatus to produce data separated in at least two dimensions at a detector;

generating from the detector an experimental dataset comprising at least separation in the first dimension on a first axis and separation in the second dimension on a second axis and extracting therefrom pattern feature data for a two-dimensional chromatogram representing the dataset;

performing a pattern recognition comparison analysis between the experimental dataset and at least one reference dataset; identifying differences in the patterns thereby;

and consequent thereon determining information about the composition producing the experimental dataset and for example identifying the characteristic presence or absence of a target material and/or a particular variation from a target or standard composition; and

optionally outputting the result.

This aspect of the invention is in principle applicable to GC×GC data however collected, but is particularly suited as a mode of operation of a device in accordance with the first aspect of the invention. GC×GC produces highly structured, ordered chromatograms in which orthogonal separations can be represented on separate and for example orthogonal axes that might in principle be suitable for pattern recognition based analysis. However pattern recognition requires accurate reproducibility between experimental and reference data. The limited reproducibility between prior art systems that is consequent upon the individual and delicate nature of the apparatus connections in a conventional assembled column device has limited consideration of such an analysis.

Conventionally collected GC×GC data have conventionally been subjected to full data analysis and identification necessitating the use of mass spectrometry or other complex apparatus which is relatively impractical in situ in the field, limiting the technique primarily to a “collect and analyse in the laboratory” regime.

A device fabricated in accordance with this aspect of the present invention produces more reproducibly consistent separation data. Accordingly, comparison of datasets or chromatograms representing this separation data to identify differences between them (and hence the underlying data) without requiring direct and full compositional analysis of the underlying data per se, but based simply on the relative position of spots and/or peaks, is made a practical proposition. Variations between the pattern of different two-dimensional pattern datasets or chromatograms, without full analytical analysis of each point within that pattern, can be used to draw practical conclusions with reference to the library of comparable pattern data.

The detailed method of pattern recognition is not pertinent to the invention. The steps involved are suitable to most conventional pattern recognition analysis routes.

The first step is the creation of a library from which can be obtained pattern feature data for two-dimensional chromatograms or separation data representing suitable reference scenarios, for example comprising scenarios referencing the presence of or absence of a target species or the variation of a sample from a standard reference condition or from a previously measured reference condition. In this context, the creation of a library from which pattern feature data can be obtained encompasses the creation of a library of extracted pattern feature data and the creation of a library of two-dimensional chromatograms or of two-dimensional separation data from which pattern feature data can be extracted during the comparison phase below.

The second step is the measurement of an experimental dataset using a two-dimensional GC×GC apparatus, and for example the apparatus of the first aspect of the invention, to obtain a dataset for the separated sample comprising separation in the first dimension on a first axis and separation in the second dimension on a second axis.

The third step is a comparison step in which differences in the two-dimensional pattern of the experimental dataset and at least one reference dataset are identified and compositional inferences drawn. In essence, the method comprises identifying differences in a two-dimensional chromatogram of the experimental dataset and a two-dimensional chromatogram of at least one reference dataset by comparison of feature data, although chromatograms as such need not be generated.

Chromatograms may be physically displayed visually. In that case the method may further comprise the display of an experimental chromatogram and optionally further one or more reference chromatograms for comparison. In that case the steps of extracting pattern feature data and/or comparing pattern feature data may be carried out directly on the physically displayed chromatograms either manually or by suitable optical reading apparatus. Alternatively, the analysis may be carried out numerically, with chromatograms having a virtual existence as two-dimensional datasets from which pattern feature data may be extracted numerically and compared numerically to identify difference and thus be able to draw compositional inferences.

It will be understood generally that a numerical step in the method of the invention can be implemented by a suitable set of machine readable instructions or code. These machine readable instructions may be loaded onto a general purpose computer, special purpose computer, or other programmable data processing apparatus to produce a means for implementing the numerical step specified, and in particular thereby to produce a calculation means as herein described.

These machine readable instructions may also be stored in a computer readable medium that can direct a computer or other programmable data processing apparatus to function in a particular manner, such that the instructions stored in a computer readable medium produce an article of manufacture including instruction means to implement some or all of the numerical steps in the method of the invention. Computer program instructions may also be loaded onto a computer or other programmable apparatus to produce a machine capable of implementing a computer executed process such that the instructions are executed on the computer or other programmable apparatus providing steps for implementing some or all of the numerical steps in the method of the invention. It will be understood that a step can be implemented by, and a means of the apparatus for performing such a step composed in, any suitable combinations of special purpose hardware and/or computer instructions.

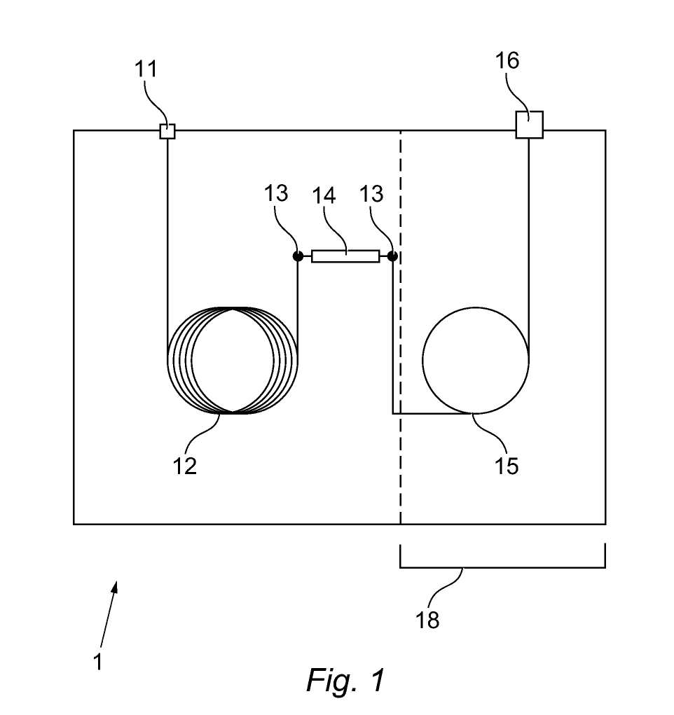

The invention will be described by way of example only with reference to FIGS. 1 to 8 of the accompanying drawings in which:

FIG. 1 is a simple diagram of a GC×GC apparatus;

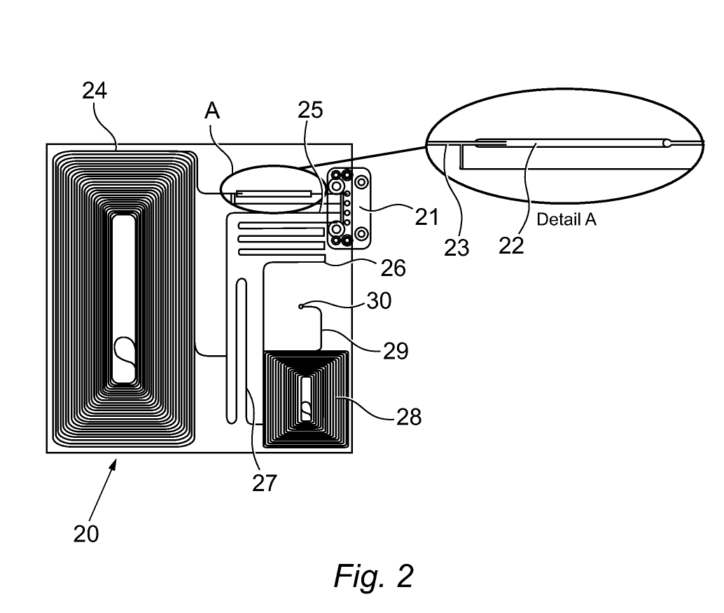

FIG. 2 is a representation of a planar substrate layer carrying an example of a chromatographic device in accordance with a first aspect of the invention;

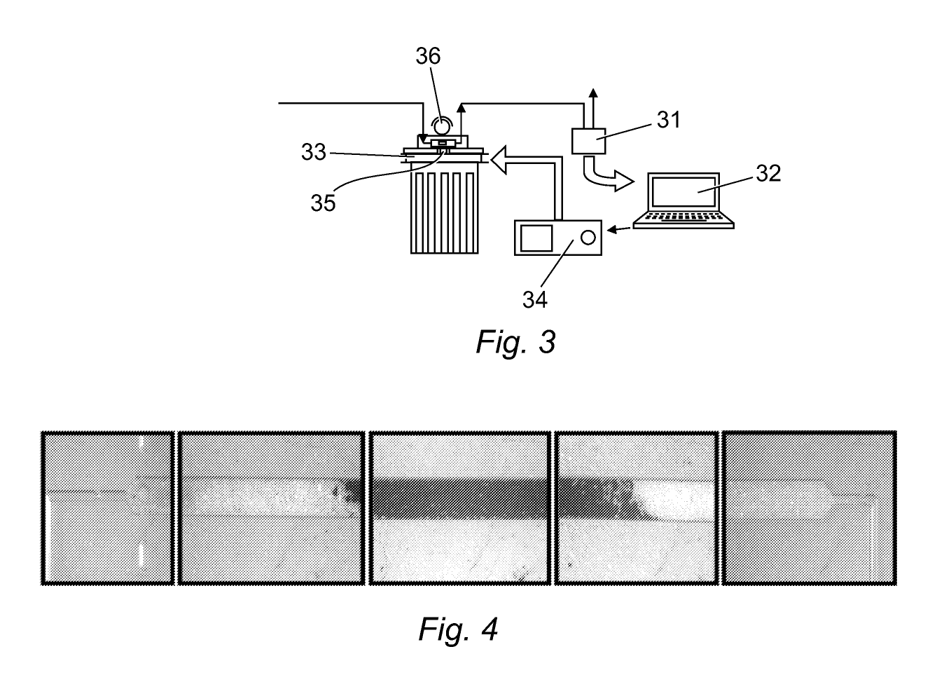

FIG. 3 is a simple schematic of a thermal desorption trap suitable for the device of FIG. 2 incorporated into a test apparatus;

FIG. 4 is a photographic representation of a thermal desorption trap such as shown in the arrangement of FIG. 3;

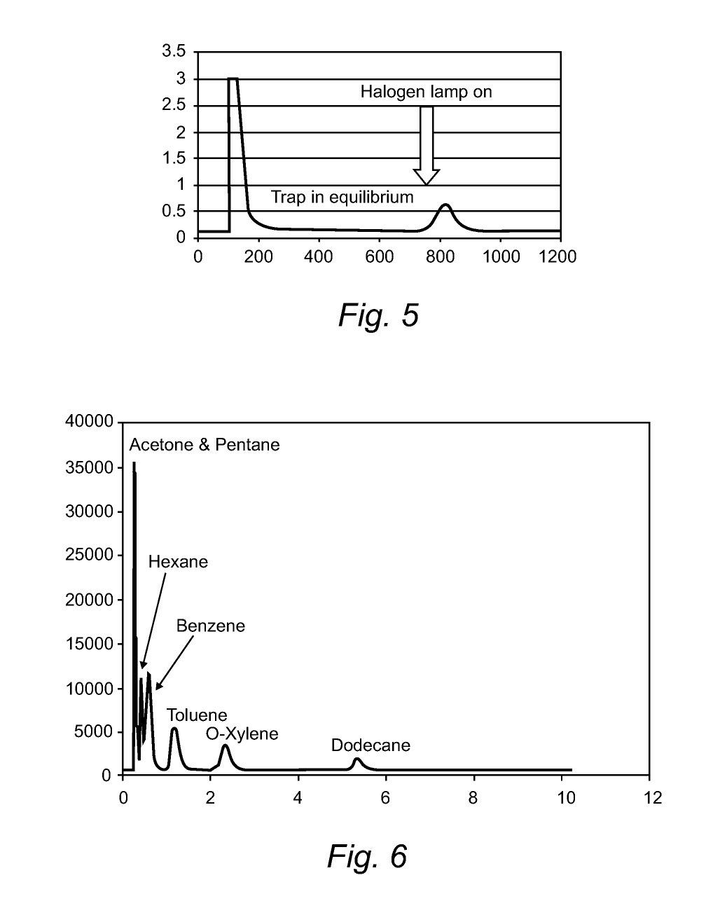

FIG. 5 is a graphical representation of the performance of the thermal desorption trap in the test system of FIG. 3;

FIG. 6 is a one dimensional chromatograph produced from the system of FIG. 3;

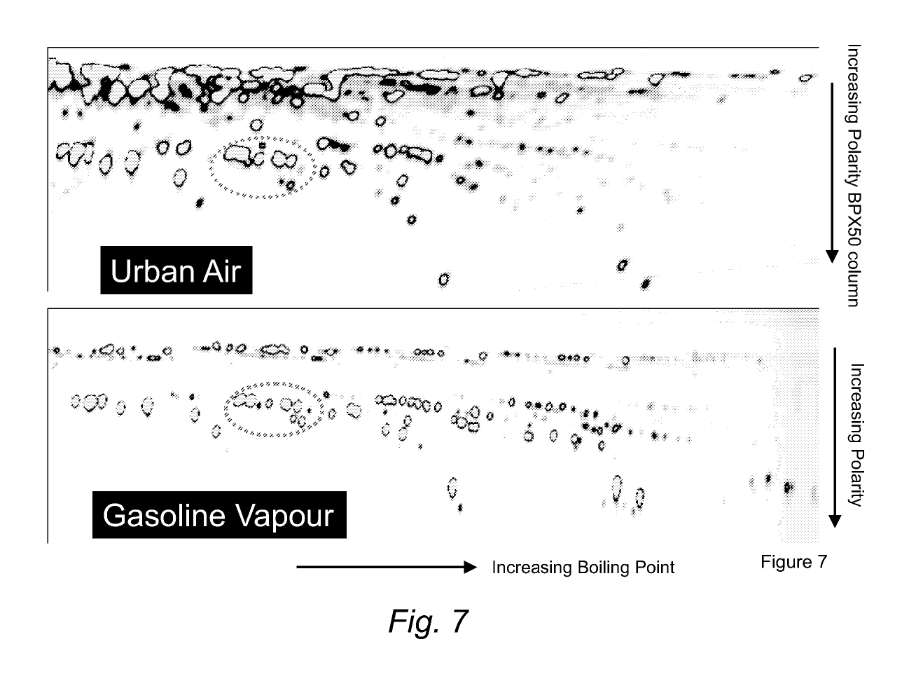

FIG. 7 is a representation of two-dimensional chromatograms to illustrate the method of the pattern-recognition aspect of the invention;

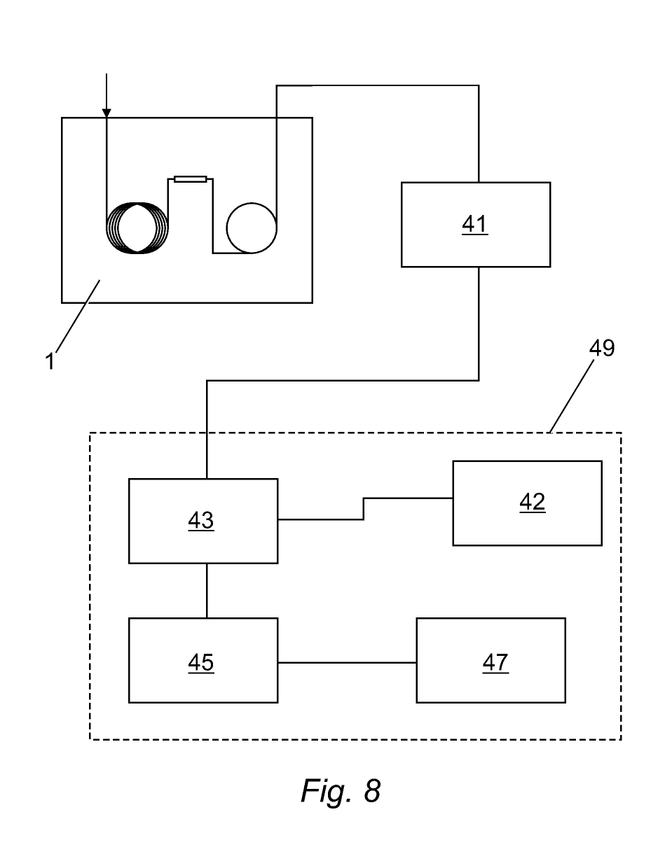

FIG. 8 is a schematic representation of an example pattern recognition methodology.

An example embodiment of a chromatographic device in accordance with a first aspect of the invention is described with reference to the general schematic of FIG. 1 (which represents a basic GC×GC apparatus whether a prior art column assembly or an assembly incorporating a device in accordance with the invention) and the specific illustration of the embodiment in FIG. 2.

A sample is injected into a chromatographic assembly 1 via injector 11 and is subject to a first dimension separation in the first stage 12. The resultant material from the first stage column passes to the modulator 14. The modulator 14 collects and injects successive fractions into the second stage 15 so as to preserve first dimension separation. The second stage 15 then performs a separation independently of the separation in the first stage, with the separation in the first stage also being substantially maintained. The material with this two-dimensional separation is passed to a detector 16 and the results processed in the usual manner. Columns 12, 15 and modulator 14 are connected in series via the joints 13. The assemble structure may be heated/cooled for example by placing in an oven or similar volume. The second stage (zone 18 to the right of the broken line) may be separately heated/cooled for example by provision of separate ovens.

In accordance with the embodiment illustrated in FIG. 2, a number of the foregoing components are microfabricated by acid etching into a single glass substrate layer. The glass substrate layer is a sandwich structure of modified soda glass. The sandwich structure comprises two layers, into each of which is fabricated a complementary pattern of grooves. The etching process used in the example is a standard photolithographic isotropic etch. Chrome and photoresist layers are laid down on the glass surface. The photoresist layer is exposed in a suitable pattern by use of a mask and developed. The chrome layer is etched through the developed photoresist layer. The exposed glass is wet etched with an HF-based reagent and the remaining chrome and photoresist layers removed.

At least for the pattern intended to form the tubes of the first and second stages, approximately semicircular grooves are created. These form, when the two complementary surfaces of the two layers of the sandwich structure are brought together, microfabricated channels of approximately circular cross section. In the particular embodiment, one layer making up the sandwich structure is around 0.30-0.40 mm thick, the other layer is around 2 mm thick, and the microfabricated channels have a diameter of around 0.25 mm. The resultant sandwich structure has reasonable structural strength, but ensures that the micro channels created within the sandwich lie near to one of the surfaces and extend in a column direction that is parallel to the plane of the substrate. This can be a particular advantage if it is desired to employ microcontrolled heating or cooling structures for example planar thermoelectric heaters in close association with the surface (not shown). Such microcontrolled heating or cooling structures act to vary the substrate temperature and thus the column temperature. Because each column in the structure of the invention is planar, lies in the substrate plane, and conveniently lies near the surface of a relatively thin substrate, heating and cooling may be effected efficiently. In particular, any thermal gradients are axial across the column width only, and not longitudinal along a part of the column length.

The resultant structure forms a 95 mm×95 mm square.

A four way connector 21 in the form of a PEEK fluidic interconnector provides a common connection means for an input for a sample to be separated and for an inlet and outlet for a valve control means operating in conjunction with a partially microfabricated modulator (see below). In fluid series, the following components are then microfabricated within the glass substrate layer. Where dimensions are given, it will be understood that these are for illustrative purposes only and do not limit the scope of the invention.

A concentrator 22 comprises a volume microfabricated to a diameter of around 1 mm and length of around 20 mm and containing a carbon bed which forms part of the injection apparatus in familiar manner. The concentrator thus comprises a microfabricated carbon thermal desorption trap. An example heating means in the form of a halogen bulb, and example operational data, are described with reference to FIGS. 3 to 6 below.

The sample then passes via the connecting channel 23 into the first stage column structure 24 which comprises in the embodiment a column length of 10 m formed from a microfabricated tube of depth 250 μm and width 260 μm. The separated sample is collected into successive fractions by a modulator structure 25, 26, 27 (discussed in greater detail below) and then, injected in successive pulses to preserve first dimension separation as described above, into the second stage column structure 28 which comprises in the embodiment a column length of 1 m formed from a microfabricated tube of depth 250 μm and width 260 μm. A sample with two dimensions of separation passes via the output channel 29 to an outlet 30 which may be provided with a suitable connection for a detector of any suitable design.

The first stage column is 10 m long. The second stage is 1 m. Both have the same bore in the embodiment, although it may be preferable for the second stage to have a narrower bore than the first stage. Stationary phases lining the bores of the two stages are for example based on polysiloxanes. A suitable non-polar stationary phase for the first stage comprises methylpolysiloxane. A suitable more polar stationary phase for the second stage comprises 50% phenyl 50% methyl polysiloxane.

The modulator is a differential-flow modulator and is partly microfabricated within the glass layer. The modulator comprises, microfabricated in the glass structure, flow channels 25 with a length of 80 mm, depth 250 μm and width 260 μm, and 26 with a length of 250 mm, depth and width 260 μm in fluid series with and connected through the four way connector 21 which provides means to inject a periodic auxiliary flow to flush sample into the second stage as successive pulses, and flow channel 27 with a length of 120 mm, depth 250 μm and width 500 μm in parallel. The integral fabrication of most of the modulator, and the simple connection of the valve into the inlet/outlet at the respective T-junctions, makes for simpler assembly.

The device of the invention offers the potential to develop a compact miniaturized separation, detection and sensor instrument in a form that is low cost, fully autonomous and yet has all the capabilities of today's laboratory based instruments. Reducing size and power allows instruments to be used in the field and in locations where mains electricity may not necessarily be available. In a further more complete aspect of the invention, a chromatographic device of the first aspect of the invention is disposed as part of a multi-dimensional GC measuring instrument.

In a particularly preferred embodiment it is possible to reduce energy consumption of such a GC measuring instrument from current values of the order ˜5×10⁷ J, to around 500 J. Effectively this moves from a 2-3 kW device requiring mains electricity to a device using peak powers of the order 50-100 W. At these energy levels device operation from solar/wind charging becomes feasible and disconnection from mains electricity for very remote monitoring, becomes possible.

FIG. 3 illustrates a schematic of test rig for a novel thermal desorption trap suitable for incorporation into the substrate of a the device in accordance with the invention such as the chip of FIG. 2, and incorporating a halogen heated thermal desorption system.

A thermal desorption trap comprising a microfluidic channel with a volume containing a suitable volatile adsorbent medium is shown fluidly connected to receive and concentrate a sample under test and to pass the sample to a photoionization detector 31 which communicates with a suitably programmed computer 32 to perform an analysis in the usual manner. The thermal desorption trap under test in FIG. 3 comprises in the preferred case a module suitable to be microfabricated integrally with the chip of FIG. 2, for example comprising a volume with a diameter of around 1 mm and length of around 20 mm, which is provided with a carbon bed adsorber to form a thermal desorption trap. For example, the ends of the trap are packed with glass beads, and the central adsorbing region with a suitable carbon based volatile adsorbent such as Carbopack 60/80 mesh.

These principles of the trap are illustrated in FIG. 4, in which the module of FIG. 3 is illustrated formed into the substrate of the chip of FIG. 2.

Heating of the thermal desorption module is effected by a radiant heating source such as the illustrated 12V, 10 W halogen bulb 36. The temperature control of the device as is additionally effected by a Peltier element 33 under control of a programmable dc supply 34. Temperature is monitored by a thermistor 35 bonded to the chip.

Volatiles introduced into the test device are concentrated by the adsorbent trap in the usual manner. Given the relatively rapid desorption rate needed to give an effective, concentrated injected pulse of material from such an adsorbent trap into a first column of a GC structure, a relatively rapid heating rate is required. In the case where the trap is integrated into the chip substrate, it is not necessarily desirable to apply this relatively rapid heating rate indirectly via heating of the chip substrate or to provide resistance heated wires in the structure. Instead, in the embodiment, the radiant halogen heater 36 acts directly upon the dark carbon based adsorbent via the relatively transparent chip substrate material.

FIG. 5 illustrates graphically experimental data from halogen heating of the adsorbent trap test apparatus shown in FIG. 3. Pentane vapour is added at 100 s at 10° C., then left to reach equilibrium. A 5 W halogen bulb is switched on for 30 s at 770 s. Analytes are desorbed and detected via the photoionization detector. The graph shows that the novel design of adsorbent trap is suitable for integration into the substrate of a chip in accordance with the invention such as that of FIG. 2. In a preferred embodiment, a chip in accordance with the invention such as that of FIG. 2 is provided with such an integral adsorbent trap and remote radiant heating arrangement.

FIG. 6 illustrates graphically experimental data comprising a single dimension chromatograph from the chip shown in FIG. 2 for a range of volatile and semivolatile hydrocarbons.

In two dimensional operation, the data collected at the detector exhibits two dimensions of separation which can be represented for example in a two dimensional chromatogram in which each dimension of separation is presented on an orthogonal axis, and in which such cues as colour or hue are used to give an indication of intensity. Suitable chromatograms are illustrated in FIG. 7.

FIG. 7 compares an upper chromatogram comprising an urban air sample with a lower chromatogram comprising a standard reference for gasoline. Separation data is represented in two dimensions with the x-axis being separation in a first stage, essentially by boiling point on a non-polar stationary phase such as 100% dimethylpolysiloxane, and the y-axis being separation in a second stage, via a polar stationary phase such as BPX50 (50% phenyl polyphenyl-siloxane). A pattern characteristic of gasoline vapour is circled. In principle pattern matching of spots between source (gasoline) and receptor (urban air) can indicate the presence of gasoline in the urban air chromatogram without the need for any specific chemical description. The data so presented lends itself to analysis via a pattern recognition process in accordance with an embodiment of a further aspect of the invention as is illustrated in FIG. 4. FIG. 4 can be considered to represent schematically either general process steps or general apparatus modules for such an embodiment of this aspect of the invention.

Such chromatograms can be generated in principle by any conventional multi-dimensional GC apparatus such as is represented schematically in FIG. 1. However it is a particular advantage of the first aspect of the present invention that the number of connections and the individuality of any assembly used for GC analysis is much reduced by the provision of a large part of the necessary columnar apparatus in a single integral layer. This makes patterns such as those represented in FIG. 3 much more reproducible between systems and between measurements. A particular advantage of this is that the resultant data lends itself particularly effectively to analysis via a pattern recognition process.

With reference to FIG. 8, a two-dimensional column 1 is used to generate two-dimensional separation in the manner described in relation to FIG. 1. The resultant output to the detector (16 in FIG. 1) need not, in accordance with this example mode of operation, be fully processed for example by mass spectrometry, to identify and specifically characterise each individual detected concentration. Instead, a multiple dimensioned data generation module 31 is used to create a dataset representing this data in at least two dimensions positionally on orthogonal axes representing respectively retention time in the first stage and retention rime in the second stage, and containing further information regarding intensity. Where reference is made here for convenience to the generation of a chromatogram, this term should be understood to include the generation of a dataset having the necessary two-dimensional structure, without necessarily reproducing that dataset in a displayed form. A virtual pattern may be processed numerically. However, conveniently, the dataset generated by the data generation module 31 can additionally or alternatively be presented for visual display as a visual chromatogram.

The key to the method of the invention is that this data is further analysed to perform a pattern recognition with comparable data in a library representing, for example without limitation, known materials, known combinations in materials, environmental standards, previously measured environmental conditions etc. Variations in the patterns can then be used to generate an indication of the presence or absence of a particular species, of deviation from a standard or from previous norms etc.

In accordance with the embodiment, the pattern recognition process is carried out as a numerical analysis via a processing system 39 which may for example be a suitably programmed computer or network of computers. However, it will be apparent that individual steps of the process could be carried out manually from reproduced chromatograms.

A data store 32 stores a library of reference chromatograms for the above indicated purposes. A pattern extraction module 33 extracts pattern data items concerning both the dataset generated by the data generation module 31 and at least one dataset from those stored in the library 32. A comparator 35 effects a comparison between the pattern features for the generated dataset and the dataset(s) in the library and outputs a result in cooperation with the results module 37. Thus, inferences can be drawn about composition from patterns in the two-dimensional dataset alone without needing specifically to reference and characterise individual points within that pattern. The complex apparatus that would be used to carry out such a specific characterisation, for example including mass spectrometry equipment and the like, is not necessary. A simple analysis can be carried out in the field using a compact device in accordance with the first aspect of the invention, and for example processing the data locally or remotely via suitable computer processing means.

1. A chromatographic device for use in multi-dimensional GC comprising:
a gas flow channel means having an inlet and an outlet, and including a first length of tube defining a first stage and a second length of tube defining a second stage;
wherein each of the first length of tube defining a first stage and second length of tube defining a second stage is microfabricated in a planar substrate layer such that each length of tube extends in the plane of the substrate layer and comprises a bore defining a closed curve in cross section.

2. A chromatographic device in accordance with claim 1, wherein each of the first length of tube defining a first stage and second length of tube defining a second stage defines a substantially circular bore.

3. A chromatographic device in accordance with claim 1, wherein the planar substrate layer is glass.

4. A chromatographic device in accordance with claim 3, wherein the glass substrate layer is an alkali metal oxide glass.

5. A chromatographic device in accordance with claim 1, wherein each of the first length of tube defining a first stage and second length of tube defining a second stage is microfabricated via a chemical etch process.

6. A chromatographic device in accordance with claim 5, wherein each of the first length of tube defining a first stage and second length of tube defining a second stage is acid etched.

7. A chromatographic device in accordance with claim 1, wherein the planar substrate layer comprises a sandwich structure in which complementarily microfabricated curved grooves are formed in a pair of opposing sandwich layers, and the layers are bonded together to form a planar substrate layer and thereby define the said first and second lengths of tube.

8. A chromatographic device in accordance with claim 1, further comprises heating and/or cooling means disposed to heat and/or cool independently or together, some or all of: the first length of tube defining a first stage, the second length of tube defining a second stage, a modulator, or any other functional component.

9. A chromatographic device in accordance with claim 8, wherein the heating and/or cooling means is a planar structure disposed in proximity to the glass substrate layer.

10. A chromatographic device in accordance with claim 1, wherein the first stage comprises a tube with a column length between 1 and 30 m and a bore diameter of the order of 0.05 to 0.50 mm.

11. A chromatographic device in accordance with claim 1, wherein the second stage comprises a tube with a column length between 0.1 and 2.0 m and a bore diameter of between 0.05 and 0.30 mm.

12. A chromatographic device in accordance with claim 1, wherein the first stage comprises a generally non-polar stationary phase and the second stage comprises a stationary phase that offers more polar characteristics.

13. A chromatographic device in accordance with claim 1, further comprising a modulator at the end of the first stage to accumulate successively over successive time periods concentration fractions of sample received at the end of the first stage and to release each accumulated fraction as a concentration pulse into the second stage.

14. A chromatographic device in accordance claim 13, wherein the first stage, second stage and modulator are configured such that retention time within the second stage is less than a band resolution time of the first stage.

15. A chromatographic device in accordance with claim 13, wherein the modulator is at least partly composed in a microfabricated modulator volume in fluid communication with and lying fluidly between the first and the second stages.

16. A chromatographic device in accordance with claim 15, further comprising a sample concentration structure including a thermal desorption module upstream of the first stage.

17. A chromatographic device in accordance with claim 16, wherein the thermal desorption module comprises a microfabricated thermal desorption trap comprising a concentration medium disposed in a microfabricated desorption trap volume in fluid communication with and lying fluidly upstream of the first stage.

18. A chromatographic device in accordance with claim 17, further comprising a radiant heater spaced from and configured to heat the concentration medium directly.

19. A chromatographic device in accordance with claim 17, wherein the first length of tube defining a first stage, the second length of tube defining a second stage, the modulator volume and the desorption trap volume are fabricated in a single common planar substrate layer.

20. A chromatographic device in accordance with claim 1, adapted by provision of connection means to be assembled with one or more of: injector means to introduce a sample entrained in carrier gas through the inlet and into the first stage; a modulator; a detector to receive sample from the outlet of the second stage.

21. A multidimensional GC assembly comprising a chromatographic device in accordance with claim 1 in fluid connection with one or more of:
injector means to introduce a sample entrained in carrier gas through the inlet and into the first stage; a modulator between the first and the second stage;
a detector to receive sample from the outlet of the second stage.

22. An assembly in accordance with claim 18, further comprising a non-mains power source and adapted to operate at a peak power consumption of less than 100 W.

23. A method of fabrication of a chromatographic device for use in multi-dimensional GC comprising the steps of:
providing at least one planar substrate layer;
microfabricating within the planar substrate layer(s) a fluidly continuous gas flow channel means having an inlet and an outlet, and including a first length of tube defining a first stage and a second length of tube defining a second stage;
such that each length of tube extends in the plane of the substrate layer and comprises a bore defining in cross section a closed curve, and in particular being substantially circular in cross section.

24. A method in accordance with claim 23 wherein a length of tube is fabricated by means of:
forming complementarily patterned grooves in opposing surfaces of each of a first and second layer of a sandwich structure;
bringing the first and second layers of the sandwich structure into contact and for example bonding to form a length of tube defining in cross section a closed curved bore comprising each of the first and second stages.

25. A method in accordance with claim 23, wherein the planar substrate layer is glass.

26. A method in accordance with claim 23, wherein the first length of tube defining a first stage and the second length of tube defining the second stage are microfabricated by wet chemical acid etching.

27. A method of fabricating a chromatographic assembly in accordance with claim 23 comprising one or more of the further steps of:
providing in fluid communication between the first stage and the second stage a modulator adapted in use to accumulate successively over successive time periods concentration fractions of sample received at the end of the first stage and to release each accumulated fraction as a concentration pulse into the second stage;
providing fluidly upstream of the first stage injector means to introduce a sample entrained in carrier gas through the inlet and into the first stage;
providing fluidly downstream of the second stage a detector to receive separated sample from the outlet of the second stage.

28. A method of processing the data from a multi-dimensional GC apparatus to obtain information concerning a sample comprises the steps of:
providing a library of datasets of multi-dimensional chromatography data representing reference conditions, comprising at least two-dimensional separation, from which pattern feature data for a two-dimensional chromatogram representing each dataset can be obtained;
injecting a sample under test into a multi-dimensional GC apparatus;
operating the apparatus to produce data separated in at least two dimensions at a detector;
generating from the detector an experimental dataset comprising at least separation in the first dimension on a first axis and separation in the second dimension on a second axis and extracting therefrom pattern feature data for a two-dimensional chromatogram representing the dataset;
performing a pattern recognition comparison analysis between the pattern feature data for the experimental dataset and that for at least one reference dataset;
identifying differences in the patterns thereby; and
consequent thereon determining information about the composition producing the experimental dataset.
